(19) United States
(12) Patent Application Publication
(10) Pub. No.: US 2016/0309705 A1
(43) Pub. Date: Oct. 27, 2016

(54) DECOY

(71) Applicant: Sarah L. Johnson, Roseville, MN (US)

(72) Inventor: Sarah L. Johnson, Roseville, MN (US)

(21) Appl. No.: 15/136,506

(22) Filed: Apr. 22, 2016

Related U.S. Application Data
(60) Provisional application No. 62/151,813, filed on Apr. 23, 2015.

(51) Int. Cl. A01M 31/06; F16M 11/08

(52) U.S. Cl. CPC A01M 31/06; F16M 11/08; F16M 2200/00

(57) ABSTRACT

A decoy assembly includes a decoy body, a stake member extending through a thickness of the decoy body, a resilient member attached to or formed integrally with a lower end of the stake member, and a base member attached to the resilient member. The decoy body is allowed to travel up and down along the length of the stake member. Also, the decoy body makes rotational movement about the stake member, and pivot relative to the base member.

### FIELD

This disclosure relates generally to decoys and, and particularly, but not by way of limitation, to decoys that can be animated by wind in the environment of use.

### BACKGROUND

Decoys have been in use for years. Decoys may be used for waterfowl or various other types of migratory birds, or other animals. Decoys may further be stationary or movable during use. Stationary decoys are generally positioned directly upon the ground or supported above the ground with a stake or other fixed object. For a decoy to be movable, various power sources may be utilized.

Generally, since the number of decoys to be utilized can be numerous, batteries, as an electronic power supply, are not preferred, since the decoy, and the batteries needed to power it, can be expensive. The decoys are also often used in wet or rainy environments, thus possibly damaging the electrical components.

Wind powered decoys have been used. Most wind powered decoys require high wind speeds to obtain any movement; however, the wind speed is not very often predictable and can be nonexistent at times.

Springs have used to allow for movement of the decoys. However, the performance of the spring is somewhat limited such that the decoys cannot make the movements as desired. There is a need for an improved wind decoy that can be efficiently and effectively animated by wind.

### SUMMARY

In some embodiments, a decoy assembly may include a decoy body made of lightweight materials, a stake member about which the decoy body can rotate freely, a resilient member that allows the stake to pivot, and a base on which the decoy body is supported. For example, the decoy body can have a substantially two-dimensional configuration (defined in the Detailed Description below) that has a plurality of air flow channels extending through a thickness of the decoy body. In such circumstances, the decoy body can make three or more types of movement. As a result, an irregular and more realistic movement by the decoy body can be created in response to the air flow.

Particular embodiments may include a decoy assembly having a decoy body, a stake member extending within a thickness of the decoy body, a resilient member attached to or formed integrally with a lower end of the stake member, and a base member attached to the resilient member. The decoy body may be allowed to make linear movement by traveling up and down along the length of the stake member. The decoy body may be allowed to also make rotational movement about the stake member. In addition, he resilient member may allow the decoy body to also make pivotal movement by pivoting relative to the base member.

In a preferred embodiment, the resilient member may include a large diameter section having a plurality of revolutions with a first diameter, a tapered section, and a small diameter section having a plurality of revolutions with a second diameter smaller than the first diameter. The tapered section may have a first end connected to the large diameter section and a second end connected to the small diameter section. A diameter of the first end of the tapered section may be smaller than a diameter of the second end of the tapered section.

In some embodiments, a decoy assembly kit may include a decoy body, a stake member, a resilient member attachable to or formed integrally with a lower end of the stake member, a base member attachable to the resilient member, an instruction for use that instructs the decoy body, the stake member, the resilient member and the base member to a decoy assembly, and packaging. Once assembled, the decoy body may be allowed to travel up and down along the length of the stake member, to makes rotational and rocking movement about the stake member, and to pivot relative to the base member.

Other embodiments may include a resilient member configured to support a decoy body. The resilient member may include a large diameter section having a plurality of revolutions with a first diameter, a tapered section, and a small diameter section having a plurality of revolutions with a second diameter smaller than the first diameter. The tapered section may have a first end connected to the large diameter section and a second end connected to the small diameter section. A diameter of the first end of the tapered section may be smaller than a diameter of the second end of the tapered section.

These and other embodiments may provide one or more of the following advantages. First, some embodiments of the decoy assembly can make different types of movement, and as a result, applying an irregular and more realistic motion to the decoy body. Second, the stake that extends through a channel formed in the decoy body allows the decoy body to rotate freely about a rotation axis. Third, the resilient member on which the decoy body is supported allows the decoy body to pivot in various directions. Fourth, a clearance formed between the upper stop and the upper edge of the decoy body allows the decoy body to move up and down along the length of the stake member. Fifth, the decoy body can be made of a corrugated plastic sheet, and as a result, the air flow channels formed in the corrugated plastic sheet allow air to flow freely through the channels, thereby creating air movement over the outer surfaces of the decoy body, and thus promoting movement of the decoy body.

This Summary is an overview of some of the teachings of the present application and not intended to be an exclusive or exhaustive description of the claimed invention. Further details about the present subject matter are found in the detailed description and appended claims. Other aspects of the subject matter will be apparent to persons skilled in the art upon reading and understanding the following detailed description and viewing the drawings that form a part thereof, each of which are not to be taken in a limiting sense. The scope of the claimed invention is defined by the appended claims and their equivalents.

### DESCRIPTION OF THE DRAWINGS

The drawings, which are not necessarily drawn to scale, illustrate generally, by way of example, but not by way of limitation, various embodiments discussed in this application.

FIG. 1 is a schematic view of a decoy assembly.

FIGS. 2A-C are schematic views of a decoy body of the decoy assembly illustrated in FIG. 1 when viewed from above the upper edge of the decoy body.

FIG. 3 is a perspective view of a further embodiment of the decoy assembly.

FIG. 4 is a partial sectional view of the decoy assembly illustrated in FIG. 3.

FIG. 5 is a front view of the decoy assembly illustrated in FIG. 3.

FIG. 6 is a side view of a decoy body of the decoy assembly illustrated in FIG. 3.

FIG. 7 is a schematic view of a resilient member and a stake of the decoy assembly illustrated in FIG. 3.

FIG. 8 is a sectional view of the resilient member and the stake of the decoy assembly illustrated in FIG. 3.

FIG. 9 is a schematic view of a base member of the decoy assembly illustrated in FIG. 3.

FIG. 10 is a kit of the decoy assembly illustrated in FIG. 3.

Like reference symbols in the various drawings indicate like elements.

### DETAILED DESCRIPTION

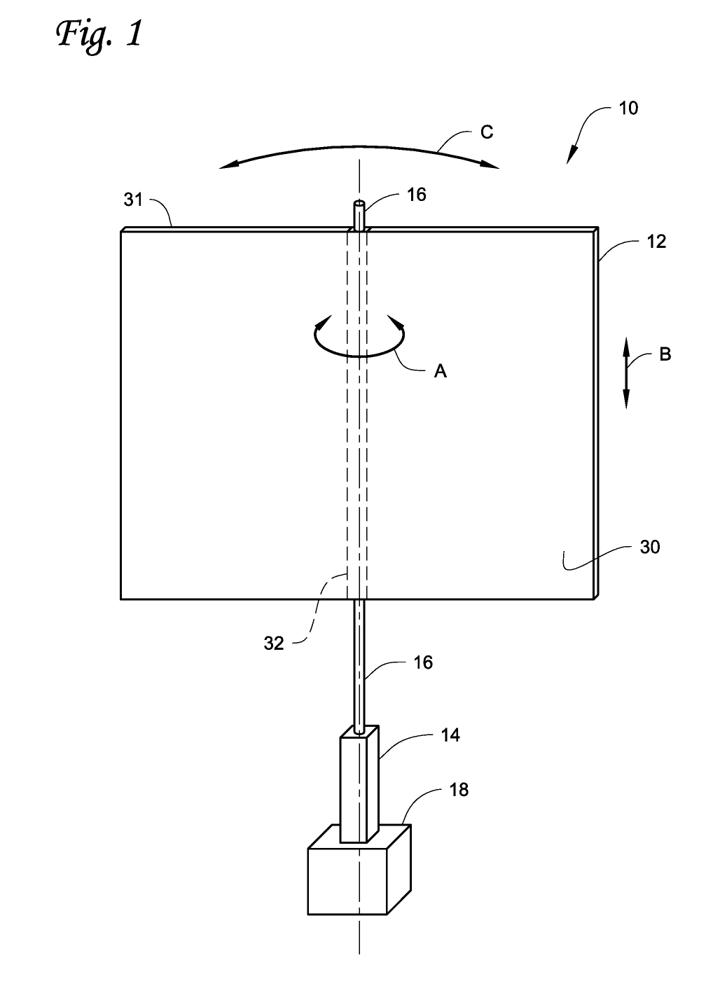

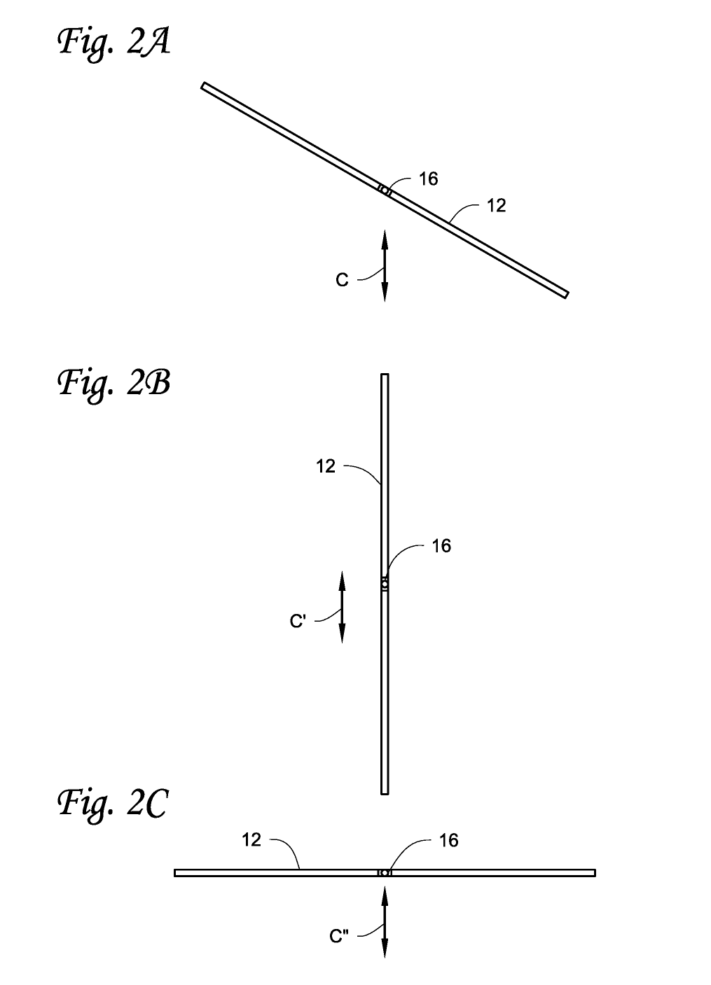

As used herein, the term “decoy assembly” refers to a wide variety of devices employed for deterring or repelling animals, birds or the like. In the context of this disclosure, the term “decoy” can also be intended for a positive sense, for example, it can be used to refer to devices employed for attracting a variety of fish, animals or the like. The term “in-plane” refers to a direction generally parallel to a major surface of a decoy body. The term “greatest in-plane dimension” refers to, when viewed from a direction perpendicular to a major surface of a decoy body, a greatest dimension of the major surface along a straight line. The term “substantially two-dimensional” refers to configurations that may be fully planar, distorted or curved, and does not exclude a third-dimensional thickness, as long as the greatest thickness of the material is no more than 5% of the greatest in-plane dimension of the material. The term “substantially vertically” refers to air flow channels of a decoy body that extend along the height of the decoy body in an up-down direction in use, for example, at an angle of about 30 degrees or less from vertical, and preferably, within 10 degrees from vertical. The term “vicinity” refers to a distance ranging from about 0.25 mm to about 50 mm for a decoy body that has a major surface area of about 0.18 square meters. The terms “above,” “on,” “under,” “top,” “bottom,” “up,” “down,” “horizontal,” and “vertical” and the like used herein are in reference to the relative positions of the decoy assembly and its constituent parts in use when oriented as in FIGS. 1, 2A-B and 3-10.

FIG. 1 shows a decoy assembly 10 configured to make three or more types of movement to apply an irregular and more realistic motion, for example, a rotational movement, a pivotal movement and a linear movement. In some circumstances, the three types of movement can be applied to the decoy assembly 10 simultaneously. The decoy assembly 10 can have a variety of designs depending on the user's desires, and is not limited to any particular design such as a particular animal species. For example, in the instances when wildlife, such as geese, ducks, turkeys, other birds, or the like, becomes a nuisance to human life or causes damage to property, the decoy assembly 10 can be used to control damage caused by nuisance wildlife without harming them, humans or the environment. In other instances, the decoy assembly 10 can be used for attracting predators, for hunting or photographing. In such circumstances, the decoy assembly 10 can be configured to have various colors and sizes as appropriate for the purpose so long as the decoy assembly 10 can make three or more types of movement.

Referring to FIG. 1, in some embodiments, the decoy assembly 10 can include a substantially two-dimensional decoy body 12. In some embodiments, the decoy body 12 has two major surfaces 30 positioned opposite to each other and a thickness defined between the two major surfaces 30. In some embodiments, the decoy body 12 can have a substantially uniform thickness and the configuration of the decoy body 12 can be fully planar, distorted or curved. In other embodiments, thickness of the decoy body 12 can vary over the surfaces 30. In some embodiments, a ratio between a greatest thickness of the decoy body 12 and a greatest in-plane dimension of the decoy body 12 can range from 0.1% to 20%. In other embodiments, the ratio between a greatest thickness of the decoy body 12 and a greatest in-plane dimension of the decoy body 12 can range from 0.5% to 5%.

The actual construction, size, and appearance of the decoy body 12 may vary depending on the user's desires. In some embodiments, the decoy body 12 may be molded or otherwise constructed out of various weather-resistant, light-weight materials such as plastic, light metals, cardboard, or the like. For example, the decoy body 12 may be constructed of plastic sheets, foam sheets, metal sheets, cardboard sheets, or other semi-rigid like material.

Still referring to FIG. 1, in some embodiments, the decoy assembly 10 can further include a stake member 16 extending within the thickness of the decoy body 12, a resilient member 14 connected to a lower end of the stake member 16, which allows the stake member 16 to pivot in various directions and a base member 18 that is placed on or mounted to the ground and supports the decoy body 12 through the resilient member 14 and the stake member 16.

In some embodiments, the decoy body 12 can include an upper edge 31 and a stake member channel 32 extending within the thickness of the decoy body 12 in a vertical direction through the decoy body 12. The stake member channel 32 can be sized to allow the stake member 16 to extend through the stake member channel 32 and be received therein. As a result, the decoy body 12 can rotate freely about the stake member 16, as shown by arrow A. In addition, the cooperation between the stake member 16 and the stake member channel 32 can also allow the decoy body 12 to travel up and down along the length of the stake member 16, as shown by arrow B.

In some embodiments, the resilient member 14 can include a spring, an elastomer member or the like that allows for pivotal movement of the stake member 16 relative to the base member 18. This in turn allows for pivotal movement of the decoy body 12 relative to the base member 18, as shown by arrow C.

It is to be understood that the pivotal movement of the decoy body 12 in this embodiment can be in any direction. For example, when the decoy body 12 is viewed from above its upper edge 31, the direction that the decoy body 12 pivots relative to the base member 18 can be a non-perpendicular and non-in-plane direction with respect to the major surfaces 30, as shown by arrow C in FIG. 2A, an in-plane direction with respect to the major surfaces 30, as shown by arrow C′ in FIG. 2B, or a perpendicular direction with respect to the major surfaces 30, as shown by arrow C″ in FIG. 2C.

The base member 18 of the decoy assembly 10 is configured to provide support and stability to the decoy assembly 10. In some embodiments, the decoy body 12 is affixed to the base member 18 through the resilient member 14 and the stake member 16. For example, the base member 18 can include an elongated post attached to the resilient member 14, with its lower end securely inserted into the ground. In other examples, in case the base member 18 needs to be placed on a flat surface, such as pavement, the base member 18 can include a flat bottom configuration that allows the decoy assembly 10 to rest on the surface.

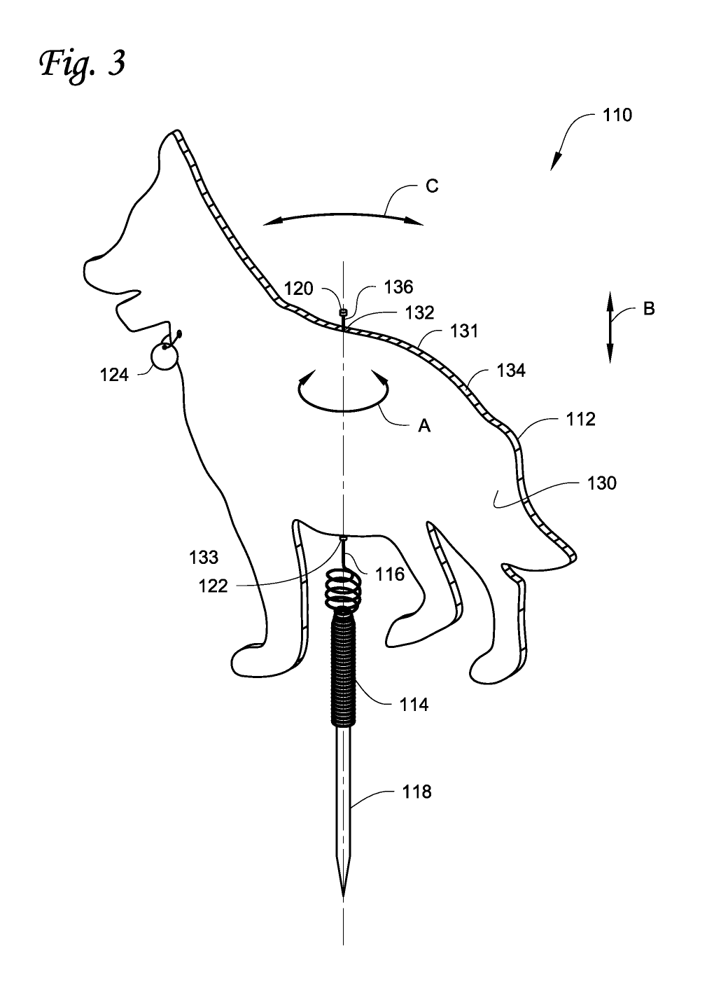

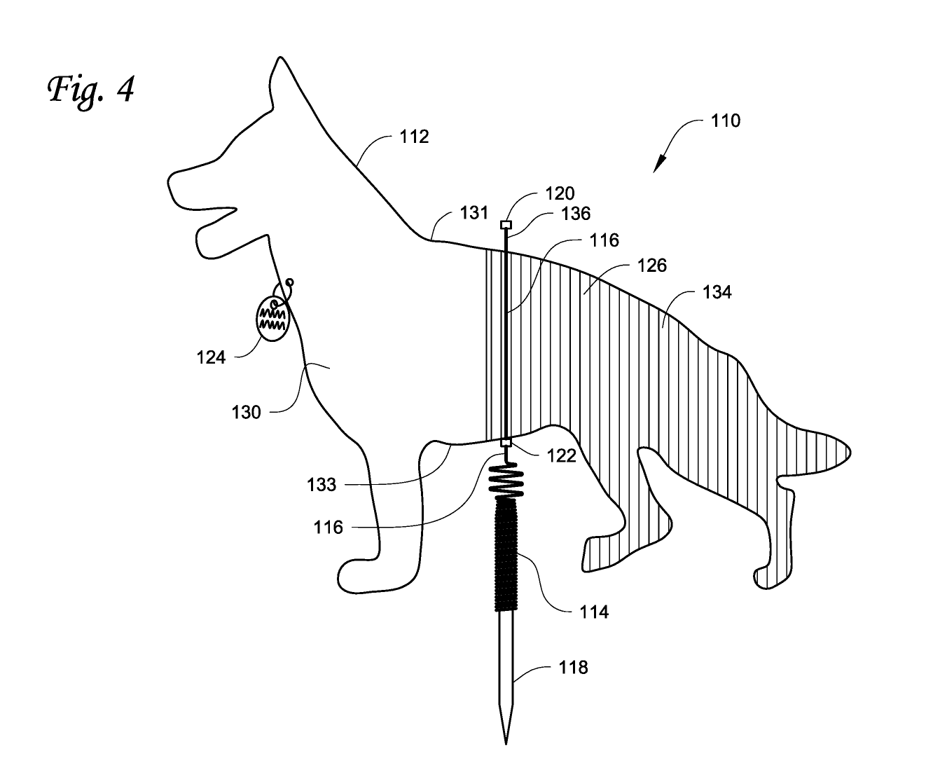

FIGS. 3-8 show a further embodiment decoy assembly 110 of the decoy assembly. Referring to FIGS. 3 and 4, like the embodiment illustrated in FIGS. 1 and 2A-C, the decoy assembly 110 is configured to make three or more types of movement to apply an irregular and more realistic motion, for example, a rotational movement, a pivotal movement and a linear movement. In some circumstances, the three types of movement can occur simultaneously.

The decoy assembly 110 can have a variety of designs depending on the user's desires, and is not limited to any particular design such as a particular animal species. The specific decoy assembly 110 depicted in FIGS. 3-8 is a deterrent predator type decoy such as a dog decoy intended to deter geese, ducks, birds, rodents and other undesired mammals, or the like from damaging the premises at which the decoy assembly 110 is deployed. The decoy assembly 110 can be configured to have various colors and sizes appropriate for the purpose so long as the decoy assembly 110 can make three or more types of movement.

Referring to FIG. 3, in some embodiments, the decoy assembly 110 can include a substantially two-dimensional decoy body 112. In some embodiments, the decoy body 112 has two major surfaces 130 positioned opposite to each other and a thickness defined between the two major surfaces 130. The decoy body 112 can have a substantially uniform thickness and the configuration of the decoy body 112 can be fully planar. In some embodiments, a ratio between a greatest thickness of the decoy body 112 and a greatest in-plane dimension of the decoy body 112 can range from 0.1% to 20%. In other embodiments, the ratio between a greatest thickness of the decoy body 112 and a greatest in-plane dimension of the decoy body 112 can range from 0.5% to 5%. In one example, the ratio between the thickness of the decoy body 112 and a greatest in-plane dimension of the decoy body 112 can be about 0.5%.

The actual construction, size, and appearance of the decoy body 112 may vary depending on the user's desires. In some embodiments, the decoy body 112 may be molded or otherwise constructed out of various weather-resistant, light-weight materials such as plastic, light metals, or the like. For example, the 12 may be constructed of PACKNET™ recyclable corrugated plastic (polyethylene) sheet available from Packnet Ltd. of Minnesota, USA.

Referring to FIG. 4, which shows the decoy body 112 with a portion of the facing of the major surface 130 removed to expose the internal structure, in some embodiments, the decoy assembly 110 can include a plurality of air flow channels 134 extending substantially vertically along the height of the decoy body 112. The air flow channels 134 can be configured to allow air to flow freely and erratically through the channels, thereby creating air movement over outer surfaces of the decoy body 112, and thus promoting movement of the decoy body 112. As a result, an irregular and more realistic motion of the decoy body can be created in response to the air flow. In some embodiments, the stake member channel 132 can be one of the air flow channels 134.

In some embodiments, the air flow channels 134 can be the elongate flutes formed in a corrugated plastic sheet. The elongate flutes can be oriented in a direction along the height of the decoy body 112. In such circumstances, these air flow channels 134 allow air flowing in different speed in different air flow channels, while the air flow speed in the air flow channels 134 can also be different from speed of the air flowing along the major surfaces 130. The different speed of air flow can help create different air pressure along the major surfaces and in the air channels, and as a result, help promote movement of the decoy body 112. In addition, the walls of the air flow channels 134 can help provide additional strength to the decoy body 112.

It is to be understood that the number of the air flow channels 134 can vary as desired. Also, a cross sectional shape of air flow channels 134 can vary as desired. For example, the cross sectional shape can take a rectangular shape, a square shape, a circular shape, or the like. In some embodiments, the width between the walls extending between the major surfaces to define the individual air flow channels 134 can be sized from about 2 mm to about 50 mm, preferably from about 5 mm to about 20 mm, and more preferably from about 4 mm to about 8 mm.

In some embodiments, the walls of the air flow channels 134 can be thin as long as the decoy body 112 has sufficient strength for its desired use. As a result, the air flow channels 134 do not hinder movement of the decoy body 112. It is to be understood that other designs of air flow channels can be adapted, as long as they allow the operational features of the air flow channels 134 to function within the decoy body 112.

In one embodiment, the decoy body 112 can have a height of about 0.6 meters, and a length of about 0.9 meters from tail to nose. In such circumstances, the thickness of the decoy body 112 can range from about 5 mm to about 9 mm. In one example, the thickness of the decoy body 112 can be about 6.3 mm. The weight of the decoy body 112 can be about ½ lbs. In some embodiments, the major surfaces 130 can have a surface area of about 0.18 square meters. A ratio between the surface area of the major surfaces 130 and the weight of the decoy body 112 can be about 0.5-1 square meter/kg, preferably about 0.7-0.8 square meter/kg.

In some embodiments, the decoy assembly 110 includes a tag 124 attached to the decoy body 112 to create a more realistic image to the decoy design. In some embodiments, the tag 124 has a different color than the decoy body 112.

Referring now to FIGS. 3 and 4, in some embodiments, the decoy assembly 110 can further include a stake member 116 extending within the thickness of the decoy body 112, a resilient member 114 connected to a lower end of the stake member 116 that allows the stake member 116 to pivot in various directions and a base member 118 that supports and stabilizes the decoy body 112 through the resilient member 114 and the stake member 116.

In some embodiments, the decoy body 112 can include an upper edge 131 and a stake member channel 132 extending within the thickness of the decoy body 112, i.e., substantially parallel to a major surface, in a vertical direction along a height of the decoy body 112. The stake member channel 132 can be sized to allow the stake member 116 to extend through the stake member channel 132 and be received therein. As a result, the decoy body 112 can rotate freely about the stake member 116, as shown by arrow A. In addition, the cooperation between the stake member 116 and the stake member channel 132 can also allow the decoy body 112 to travel up and down along the length of the stake member 116, as shown by arrow B.

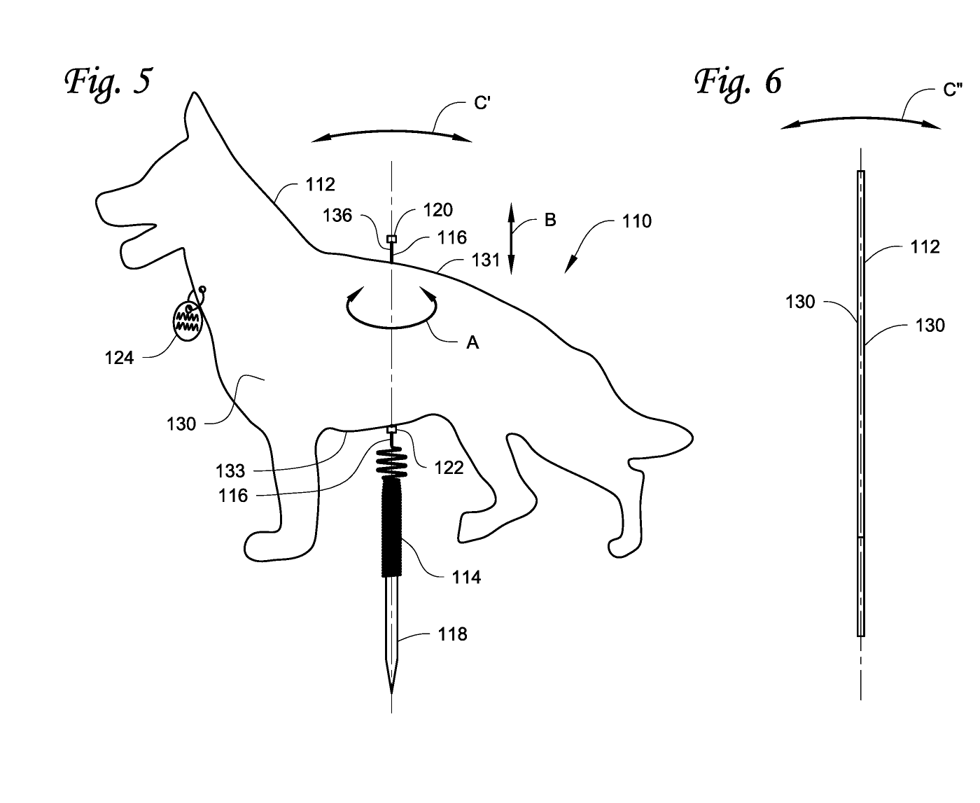

As shown in FIGS. 5 and 7-8, in some embodiments, the stake member 116 extends all the way throughout the height of the decoy body 112. The stake member 116 can include an upper stop 120 and a lower stop 122, with a clearance 136 formed between an upper edge 131 of the decoy body 112 and the upper stop 120, when the decoy body 112 rests on the lower stop 122. The clearance 136 provides leeway for the decoy body 112 to travel up and down along the length of the stake member 116, as shown by arrow B. In such circumstances, the upper stop 120 can serve as a stop, helping prevent the decoy body 112 from flying away. In some embodiments, the clearance 136 can range from about 6 mm to about 13 mm for a decoy body 112 that has a major surface area of about 0.18 square meters and has a weight of about 0.25 kg.

The upper stop 120 and the lower stop 122 can be any mechanism that performs a stop function. In some embodiments, the upper stop 120 can include a nut that can be screwed onto a top end of the stake member 116, and the lower stop 122 can include a washer 150 fixed on the stake member 116 and a pony bead 152 movable between the washer 150 and an edge 133 of the decoy body 112 when the decoy body 112 moves away from the lower stop 122.

The pony bead 152 has slightly rounded edges. The inclusion of the pony bead 152 allows the decoy body 112 to move more easily. In addition, because the pony bead 152 can rotate freely about the stake member 116, it helps reduce resistance to the movement of the decoy body 112. In one embodiment, a distance D_{LR} between the washer 150 and an upper end of the resilient member 114 can range from about 15 mm to about 25 mm.

In some embodiments, the stake member 116 is configured to extend substantially through a center of gravity of the decoy body 112. For example, when used herein, for a decoy body 112 that has a major surface area of about 0.18 square meters and has a weight of about 0.25 kg, within 20 mm to the left or right of the center of gravity is “substantially through a center of gravity.” The decoy body can be marked to indicate the location of the center of gravity, which is useful for cases in which the user assembles the device.

In some embodiments, the resilient member 114 can be a spring, such as a linear spring, a helical spring, or the like. The resilient member 114 is configured to allow for pivotal movement of the stake member 116 relative to the base member 118. This in turn allows for pivotal movement of the decoy body 112 relative to the base member 118, as shown by arrow C.

It is to be understood that the pivotal movement of the decoy body 112 can be in any direction. For example, when the decoy body 112 is viewed from above its upper edge upper edge 131, the direction that the decoy body 112 pivots relative to the base member 118 can be a non-perpendicular and non-in-plane direction with respect to the major surfaces 130, as shown by arrow C in FIG. 3, an in-plane direction with respect to the major surfaces 130, as shown by arrow C′ in FIG. 5, or a perpendicular direction with respect to the major surfaces 130, as shown by arrow C″ in FIG. 6.

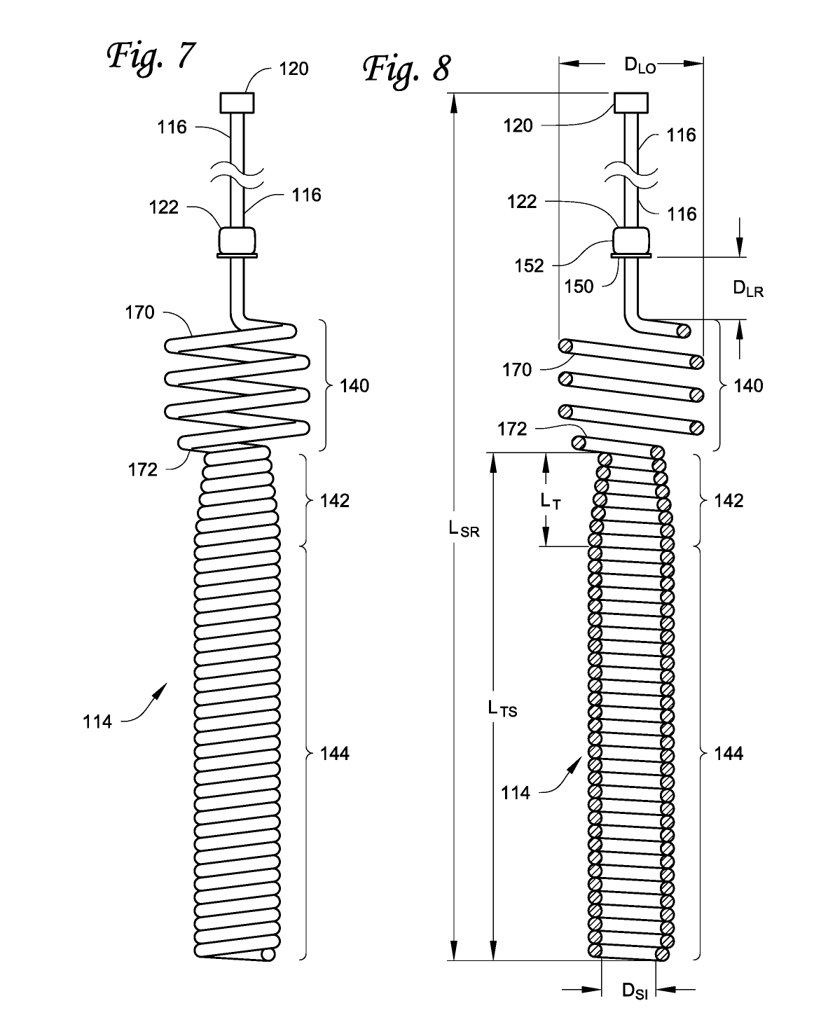

Referring now to FIGS. 3-8, and FIGS. 7 and 8 in particular, in some embodiments, the resilient member 114 is a coil spring including a larger diameter section 140, a tapered section 142 and a smaller diameter section 144. FIGS. 7 and 8 show the resilient member 114 formed integrally with the stake member 116. In some embodiments, the entire length L_{SR} from an upper end of the stake member 116 to a lower end of the resilient member 114 can range from about 0.4 meters to about 0.5 meters. However, it is to be understood that another length of the stake member 116 and the resilient member 113 can be adapted, as long as they allow the operational features of the members 114, 116 to function in the decoy assembly. In some embodiments, the entire length L_{SR} can range from about 0.2 meters to about 1 meter, and preferably from about 0.3 meters to about 0.7 meters.

Referring to FIGS. 7 and 8, the larger diameter section 140 has larger diameter revolutions spaced away from each other. In some embodiments, the larger diameter section 140 includes three larger diameter revolutions 170 which have a consistent coil diameter, and one incomplete revolution 172. In some embodiments, the larger diameter section 140 includes three larger diameter revolutions 170 which have a consistent coil diameter. An axial distance between each two adjacent revolutions in this section of the resilient member 114 can range from about 7 mm to about 10 mm for supporting a decoy body 112 that has a major surface area ranging from about 0.15 square meters to about 0.2 square meters and has a weight ranging from about 0.2 kg to about 0.3 kg. In some embodiments, an outer coil diameter D_{LO} of the three larger diameter revolutions 170 can range from about 40 mm to about 50 mm, an outer coil diameter of the incomplete revolution 172 can range from about 25 mm to about 40 mm, and the length of the larger diameter section 140 can range from about 25 mm to about 35 mm. However, it is to be understood that other designs of the larger diameter section 140 can be adapted, as long as they allow the operational features of the larger diameter section 140 to function in the decoy assembly 110. For example, the number of the revolutions in the large diameter can vary as needed, such as one, two, four or more.

Referring to FIGS. 7 and 8, the tapered section 142 can have a tapered shape from an upper end connected to the larger diameter section 140 to a lower end connected to the smaller diameter section 144. As a result, a sharper change of diameter exists at the intersection between the larger diameter section 140 and tapered section 142 relative to the diameter change at the intersection between tapered section 142 and smaller diameter section 144. The upper end of the tapered section 142 has the smallest coil diameter and the lower end has the largest coil diameter in the tapered section 142.

In some embodiments, the tapered section 142 is configured to have a diameter that is equal to or greater than an outer diameter of an upper end of the base member 118 at its lower end, and a diameter that is smaller than the outer diameter of the upper end of the base member 118 at its upper end. In such circumstances, the upper end of the base member 118 can be securely attached to the tapered section 142. In some embodiments, an inner coil diameter of the upper end of the tapered section 142 can range from about 10 mm to about 16 mm, and an inner coil diameter of the lower end of the tapered section 142 can range from about 13 mm to about 20 mm. In some embodiments, the tapered section 142 includes seven revolutions and a length of the tapered section 142 can range from about 20 mm to about 30 mm. However, it is to be understood that other designs of the tapered section 142 can be adapted, as long as they allow the operational features of the tapered section 142 to function in the decoy assembly 110.

Still referring to FIGS. 7 and 8, the smaller diameter section 144 can have a constant coil diameter. The smaller diameter section 144 is configured to have an inner diameter that is equal to or slightly smaller than the outer diameter of the upper end of the base member 118 for receiving the upper end of the base member 118. An interference fit can be formed between the inner surface of the resilient member 114 and an outer surface of the base member 118 for a secured engagement between the resilient member 114 and the base member 118.

In some embodiments, the smaller diameter section 144 has tightly contacting revolutions, and has smaller diameter revolutions relative to the revolutions of the larger diameter section 140. In some embodiments, an inner coil diameter D_{SI} of the smaller diameter section 144 can range from about 13 mm to about 20 mm. A length of the smaller diameter section 144 can range from about 100 mm to about 120 mm, and a length L_{TS} of the tapered section 142 and the smaller diameter section 144 can range from about 120 mm to about 150 mm. However, it is to be understood that other designs of the smaller diameter section 144 can be adapted, as long as they allow the operational features of the smaller diameter section 144 to function in the decoy assembly 110.

In some embodiments, the resilient member 114 has a substantially uniform coil thickness. The specific configuration of the resilient member 114 including the design of design and shape of the resilient member 114 and the coil diameter and coil thickness of the resilient member 114 can vary depending on the surface area of the decoy body 112 and the weight of the decoy body 112. In one embodiment, the coil thickness of the resilient member 114 can range from about 2.5 mm to about 4 mm for a decoy body 112 that has a major surface area of about 0.18 square meters and has a weight of about 0.25 kg. In the depicted embodiment, the resilient member 114 can be made from a metal such as steel or alloys thereof.

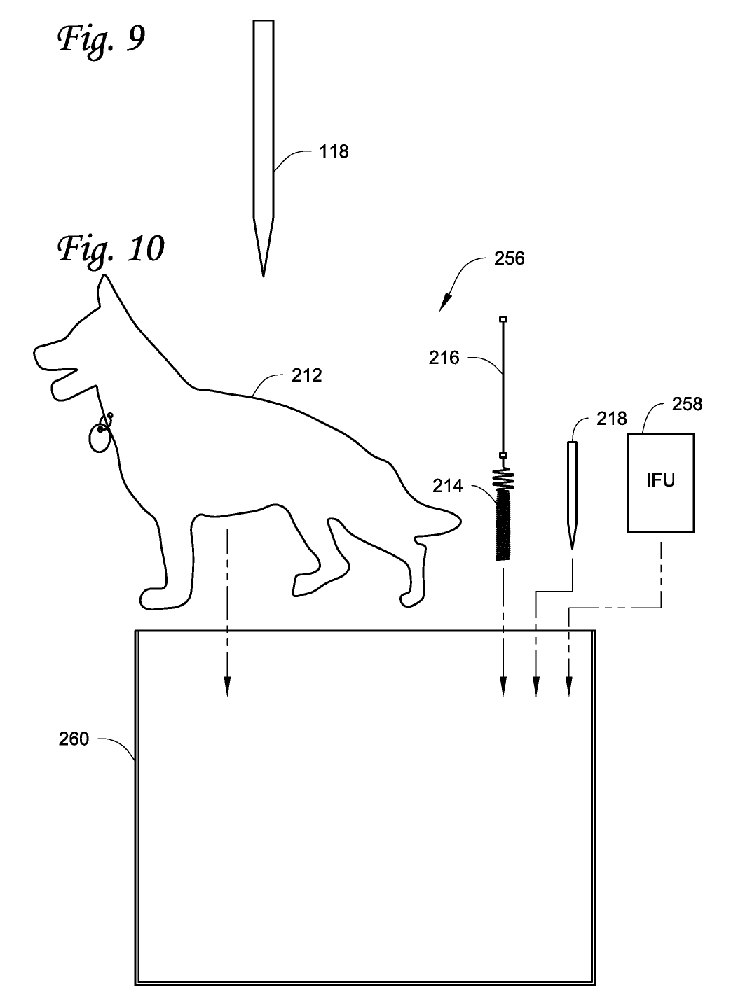

Referring now to FIG. 9, in some embodiments, the base member 118 of the decoy assembly 110 takes a form of a mounting post configured to have a sharp lower end which can be forcibly inserted into the ground. This will enable the decoy assembly 110 to be securely placed anywhere the user desires. In some embodiments, a vertical extension of the base member 118 extends through the center of gravity of the decoy body 112, or through an area in the vicinity of the center of the gravity of the decoy body 112.

To assemble the decoy assembly 110, the base member 118 can be pounded into the ground around the area in which the user desires the decoy to be used. Then the resilient member 114 is set onto the base member 118 and mounted to the base member 118. The lowest portion of the decoy body 112 can be spaced about 25 mm to 60 mm above ground, to allow the decoy body 112 to move freely in the wind. If there is grass on the ground, the lowest portion of the decoy body 112 can be spaced about 25 mm to 60 mm above the grass to allow free movement of the decoy body 112 in the wind. The decoy body 112 will continually move even in light breezes.

Referring to FIG. 10, a decoy kit 256 is disclosed herein. The decoy kit 156 may include a packaging 260, a decoy body 212, a resilient member 214, a stake member 216, and a base member 218, and instructions for use (IFU) 258 setting forth a method for assembling the decoy assembly according to the present disclosure. Instructions for use (IFU) 258 can be printed on a separate sheet of paper in the form of a package insert, but could also be printed partly or wholly on the packaging itself.

The described embodiments are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A decoy assembly comprising:
a decoy body;
a stake member extending within a thickness of the decoy body;
a resilient member attached to or formed integrally with a lower end of the stake member; and
a base member attached to the resilient member,
wherein the decoy body is allowed to make linear movement by traveling up and down along the length of the stake member,
wherein the decoy body makes rotational movement about the stake member, and
wherein the resilient member allows the decoy body to make pivotal movement by pivoting relative to the base member.

2. The decoy assembly of claim 1, wherein resilient member includes:
a large diameter section having a plurality of revolutions with a first diameter;
a tapered section; and
a small diameter section having a plurality of revolutions with a second diameter smaller than the first diameter,
wherein the tapered section has a first end connected to the large diameter section and a second end connected to the small diameter section, and the first end has a diameter smaller than a diameter of the second end.

3. The decoy assembly of claim 3, wherein a diameter of the first end of the tapered section is the smallest diameter in the resilient member.

4. The decoy assembly of claim 1, wherein the decoy body makes the linear movement, the rotational movement and the pivotal movement simultaneously.

5. The decoy assembly of claim 1, wherein the decoy body is planar and substantially two-dimensional, and has substantially uniform thickness.

6. The decoy assembly of claim 1, wherein the decoy body has two opposing major surfaces; the decoy assembly being configured to allow the decoy body to pivot in a perpendicular or in-plane direction with respect to the major surfaces.

7. The decoy assembly of claim 1, further comprising a tag having a different color than the decoy body to provide a more realistic image of an animal design than a decoy assembly without a tag.

8. The decoy assembly of claim 1, wherein the stake member includes an upper stop and a lower stop, with a clearance formed between an upper edge of the decoy body and the upper stop, when the decoy assembly rests on the lower stop.

9. The decoy assembly of claim 9, wherein the lower stop includes a fixed element and a bead element; the bead element having rounded edges and rotatable freely about a body of the stake member so as to reduce resistance to the rotational movement of the decoy body.

10. The decoy assembly of claim 1, wherein the decoy body has a plurality of air flow channels parallel to each other.

11. A decoy assembly kit, comprising:
a decoy body;
a stake member;
a resilient member attachable to or formed integrally with a lower end of the stake member;
a base member attachable to the resilient member;
an instruction for use that instructs the decoy body, the stake member, the resilient member and the base member to a decoy assembly; and
packaging,
wherein once assembled, the decoy body is allowed to travel up and down along the length of the stake member, to makes rotational and rocking movement about the stake member, and to pivot relative to the base member.

12. The decoy assembly kit of claim 11, wherein resilient member includes:
a large diameter section having a plurality of revolutions with a first diameter;
a tapered section; and
a small diameter section having a plurality of revolutions with a second diameter smaller than the first diameter,
wherein the tapered section has a first end connected to the large diameter section and a second end connected to the small diameter section, and the first end has a diameter smaller than a diameter of the second end.

13. The decoy assembly kit of claim 11, wherein the diameter of the first end of the tapered section is the smallest diameter in the resilient member.

14. The decoy assembly kit of claim 11, wherein the decoy body makes the linear movement, the rotational movement and the pivotal movement simultaneously.

15. The decoy assembly kit of claim 11, further comprising a tag having a different color than the decoy body to provide a more realistic image of an animal design than a decoy assembly without a tag.

16. The decoy assembly kit of claim 11, wherein the stake member includes an upper stop and a lower stop, with a clearance formed between an upper edge of the decoy body and the upper stop, when the decoy assembly rests on the lower stop.

17. The decoy assembly kit of claim 11, wherein the lower stop includes a fixed element and a bead element; the bead element having rounded edges and rotatable freely about a body of the stake member so as to reduce resistance to the rotational movement of the decoy body.

18. The decoy assembly kit of claim 11, wherein the decoy body has a plurality of air flow channels parallel to each other.

19. A resilient member configured to support a decoy body, comprising:
a large diameter section having a plurality of revolutions with a first diameter;
a tapered section; and
a small diameter section having a plurality of revolutions with a second diameter smaller than the first diameter,
wherein the tapered section has a first end connected to the large diameter section and a second end connected to the small diameter section, and a diameter of the first end of the tapered section is smaller than a diameter of the second end of the tapered section.

20. The resilient member of claim 19, wherein a diameter of the first end of the tapered section is the smallest diameter in the resilient member.
